(19) United States
(12) Patent Application Publication
(10) Pub. No.: US 2011/0291603 A1
(43) Pub. Date: Dec. 1, 2011

(54) DRIVE CONTROL CIRCUIT AND FOCUS CONTROL CIRCUIT

(75) Inventors: Takeshi KURA, Ogaki-shi (JP); Hiroyuki TSUDA, Ichinomiya-shi (JP); Tomonori KAMIYA, Ichinomiya-shi (JP); Hiroki NAGAI, Aichi-ken (JP)

(73) Assignee: ON SEMICONDUCTOR TRADING, LTD.

(21) Appl. No.: 13/115,586

(22) Filed: May 25, 2011

(30) Foreign Application Priority Data
May 25, 2010 (JP) 2010-119472

(51) Int. Cl. G05B 11/28

(52) U.S. Cl. 318/599

(57) ABSTRACT

An equalizer generates a control signal for adjusting, based on a difference between a target value for the state of an object and an actual measured value thereof, the state of the object to match the target value. A PWM modulation unit generates a PWM signal corresponding to the control signal generated by the equalizer. An H-bridge drive unit generates a drive current for driving a drive element that changes the state of the object in accordance with the PWM signal generated by the PWM modulation unit. A slew-rate control unit changes the current driving capability of the H-bridge drive unit in accordance with the control signal.

This application is based upon and claims the benefit of priority from the prior Japanese Patent Application No. 2010-119472, filed on May 25, 2010, the entire content is incorporated herein by reference.

### BACKGROUND OF THE INVENTION

1. Field of the Invention

The present invention relates to a drive control circuit for driving a drive element that drives an object, and a focus control circuit for determining a focus position by moving a lens that is to be the object.

2. Description of the Related Art

A drive element for controlling the state of an object is often driven by a PWM drive signal. For example, a motor for adjusting the lens position of a camera, a fan for managing the temperature inside various housings, a light for adjusting brightness, etc., are often driven by PWM drive currents. In general, a PWM drive current is generated by an H-bridge circuit.

For example, when a voice coil motor for adjusting the lens position of a camera is driven by a high-frequency PWM drive current, there is a possibility that noise is generated in an imaging element by an electromagnetic wave of the coil or noise in a power source, lowering the quality of an image signal. The noise is mainly attributed to a precipitous current change at a rising edge and a falling edge of the PWM drive current. There is a possibility that the noise also has adverse effects on an object in a field other than a camera field, for example, in a communication device field.

### SUMMARY OF THE INVENTION

A drive control circuit according to one embodiment of the present invention comprises: an equalizer configured to generate, based on a difference between a target value for the state of an object and an actual measured value thereof, a control signal for adjusting the state of the object to match the target value; a PWM modulation unit configured to generate a PWM signal corresponding to the control signal generated by the equalizer; an H-bridge drive unit configured to generate a drive current for driving a drive element that changes the state of the object in accordance with the PWM signal generated by the PWM modulation unit; and a slew-rate control unit configured to change the current driving capability of the H-bridge drive unit in accordance with the control signal.

Another embodiment of the present invention relates to a focus control circuit. The focus control circuit is mounted on an image capturing device provided with a lens, a drive element for adjusting the position of the lens, and a position detection element for detecting the position of the lens, and comprises: an equalizer configured to generate a control signal for adjusting, based on a difference between the position of the lens identified by an output signal from the position detection element and a target position of the lens that is set from the outside, the position of the lens to match the target position; a PWM modulation unit configured to generate a PWM signal corresponding to the control signal generated by the equalizer; an H-bridge drive unit configured to generate a drive current for driving the drive element in accordance with the PWM signal generated by the PWM modulation unit; and a slew-rate control unit configured to change the current driving capability of the H-bridge drive unit in accordance with the control signal.

Another embodiment of the present invention relates to an image capturing device. The device comprises: a lens; an imaging element that converts a light transmitted through the lens into an electrical signal; a drive element for adjusting the position of the lens; a position detection element for detecting the position of the lens, an image signal processor that determines a target position of the lens; and the focus control circuit for driving the drive element.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram illustrating the configuration of an image capturing device provided with a focus control circuit according to an embodiment;

FIG. 2 is a diagram explaining a determination process of a target position of a lens by an image signal processor;

FIG. 3 is a diagram illustrating an exemplary configuration of an H-bridge drive unit according to the embodiment;

FIG. 4 is a diagram explaining a plurality of sections to be selected by a slew-rate control unit; and

FIGS. 5A-5D are diagrams illustrating current waveforms generated by the H-bridge drive unit.

### DETAILED DESCRIPTION OF THE INVENTION

The invention will now be described by reference to the preferred embodiments. This does not intend to limit the scope of the present invention, but to exemplify the invention.

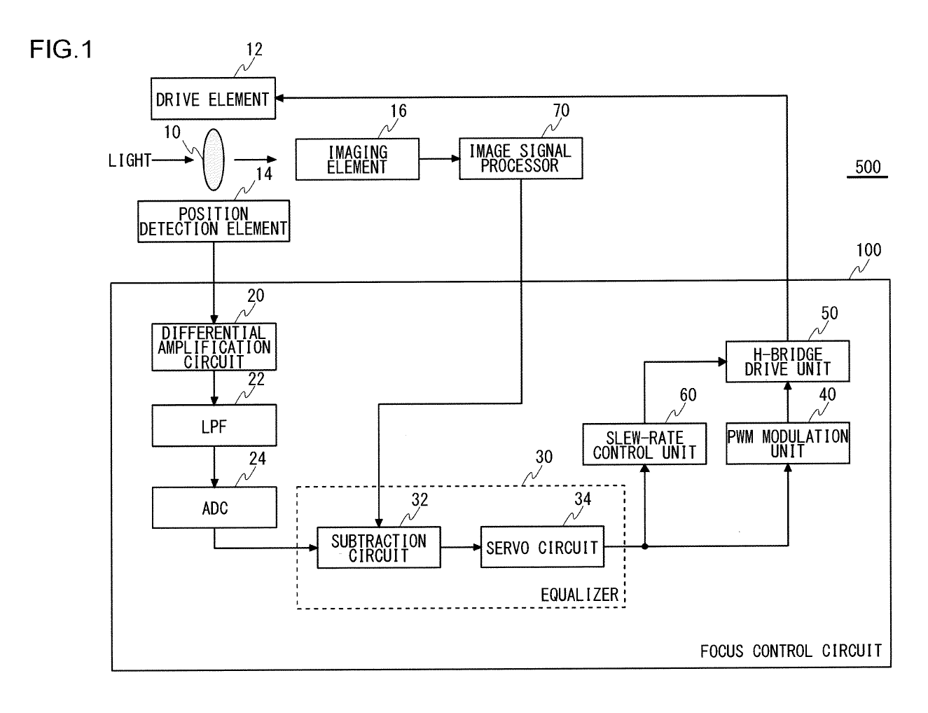

As an example of a drive control circuit in the present specification, an auto-focus control circuit is described in the following that controls a drive element for driving a lens mounted on an image capturing device. FIG. 1 is a diagram illustrating the configuration of an image capturing device 500 provided with a focus control circuit 100 according to an embodiment. The image capturing device 500 is provided with a lens 10, a drive element 12, a position detection element 14, an imaging element 16, an image signal processor (ISP) 70, and a focus control circuit 100. Constituent elements that are not related to auto-focus control such as an image encoding engine and a recording medium are omitted in the figure.

The imaging element 16 converts a light signal transmitted through the lens 10, which is an optical component, into an electrical signal and outputs the electrical signal to the image signal processor 70. As the imaging element 16, a CCD sensor or a CMOS image sensor can be employed.

The drive element 12 is an element that adjusts the position of the lens 10 and moves the lens 10 in the optical-axis direction in accordance with a drive signal provided by the focus control circuit 100. This allows a focal point distance between the lens 10 and the imaging element 16 to be adjusted. As the drive element 12, a voice coil motor (VCM) can be employed.

The position detection element 14 is an element for detecting the position of the lens 10. As the position detection element 14, a hall element can be employed. In the following, an example is described where the drive element 12 and the position detection element 14 are configured with an actuator including a voice coil motor and a hall element.

The image signal processor 70 processes an image signal output from the imaging element 16. In the present embodiment, a target position of the lens 10 is mainly determined based on the image signal output from the imaging element 16.

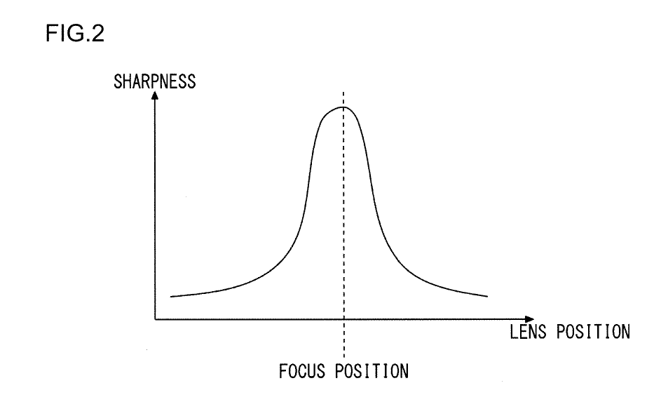

FIG. 2 is a diagram explaining a determination process of the target position of the lens 10 by the image signal processor 70. When an auto-focus function is activated, for example, when a shutter button is pressed halfway, the image signal processor 70 transmits, to the focus control circuit 100, a control signal for moving the lens 10 by a predetermined step size. In that case, the image signal processor 70 calculates the sharpness of each image signal captured at each position of the lens 10. For example, the sharpness can be obtained, after applying a high-pass filter to image signals, by extracting an edge component of each of the image signals and then by accumulating the edge components of the respective image signals. The image signal processor 70 determines the position of the lens 10, at which the sharpness is its maximum value, to be a focus position.

FIG. 1 is referred back. The focus control circuit 100 is provided with a differential amplification circuit 20, a low-pass filter 22, an analog/digital conversion circuit (ADC) 24, an equalizer 30, a PWM modulation unit 40, an H-bridge drive unit 50, and a slew-rate control unit 60. When the focus control circuit 100 is formed with a one-chip LSI, the low-pass filter 22 may be provided outside the chip.

The configurations of the equalizer 30 and the slew-rate control unit 60 are implemented by hardware such as a processor, a memory, or other LSIs and by software such as a program or the like loaded into the memory. FIG. 1 depicts functional blocks implemented by the cooperation of hardware and software. Thus, a person skilled in the art should appreciate that there are many ways of accomplishing these functional blocks in various forms in accordance with the components of hardware only, software only, or the combination of both.

The differential amplification circuit 20 amplifies the potential difference between output terminals of the position detection element 14 (a hall element in this case) and outputs the amplified potential difference as a position signal. The hall element outputs a voltage that corresponds to the magnetic flux density of a magnetic field generated by a magnet provided to the lens 10. When the magnetic flux density is changed by the displacement of the lens 10, the output voltage of the hall element also changes in proportion to the change. Therefore, the position of the lens 10 can be estimated based on the output voltage of the hall element.

The low-pass filter 22 removes a high-frequency component of the position signal output from the differential amplification circuit 20. The analog/digital conversion circuit 24 converts the position signal output from the low-pass filter 22 from an analog value into a digital value.

The equalizer 30 generates a control signal for adjusting the state of an object to match a target value based on the difference between the target value for the state of the object and the actual measured value thereof. In the present embodiment, the equalizer 30 generates a control signal for adjusting the position of the lens 10 to match the target position based on the difference between the position of the lens 10 identified by the output signal from the position detection element 14 and the target position of the lens 10 set from the outside (the image signal processor 70 in this case).

A detailed description is now given in the following. The equalizer 30 includes a subtraction circuit 32 and a servo circuit 34. The subtraction circuit 32 calculates the difference between a position signal output from the position detection element 14 and a target position signal input from the image signal processor 70 and outputs the difference as an error signal. When the position of the lens 10 is at the target position, the difference is zero. The servo circuit 34 generates a signal for cancelling out the error signal output from the subtraction circuit 32 and outputs the signal to the PWM modulation unit 40 and the slew-rate control unit 60.

The PWM modulation unit 40 generates a PWM signal corresponding to the control signal generated by the equalizer 30. More specifically, the PWM modulation unit 40 converts the control signal, which is input from the equalizer 30, into a pulse signal having a duty ratio corresponding to the digital value of the control signal. The H-bridge drive unit 50 generates a drive current for driving the drive element 12 that changes the state of the object, in other words, that moves the position of the lens 10, in accordance with the PWM signal generated by the PWM modulation unit 40. More specifically, the H-bridge drive unit 50 generates the drive current in the direction of the current and with the amount of the current that correspond to the PWM signal input from the PWM modulation unit 40 and provides the drive current to the drive element 12. This allows the lens 10 to be moved and converged toward the target position.

The slew-rate control unit 60 changes the current driving capability of the H-bridge drive unit 50 in accordance with the control signal generated by the equalizer 30. More specifically, the slew-rate control unit 60 increases the current driving capability of the H-bridge drive unit 50 as the difference between the target value and the actual measured value increases. In the present embodiment, the current driving capability is increased as the difference between the target position input from the image signal processor 70 and a position detected by the position detection element 14 (hereinafter, referred to as a detected position) increases. Contrarily, as the difference decreases, the current driving capability of the H-bridge drive unit 50 is decreased.

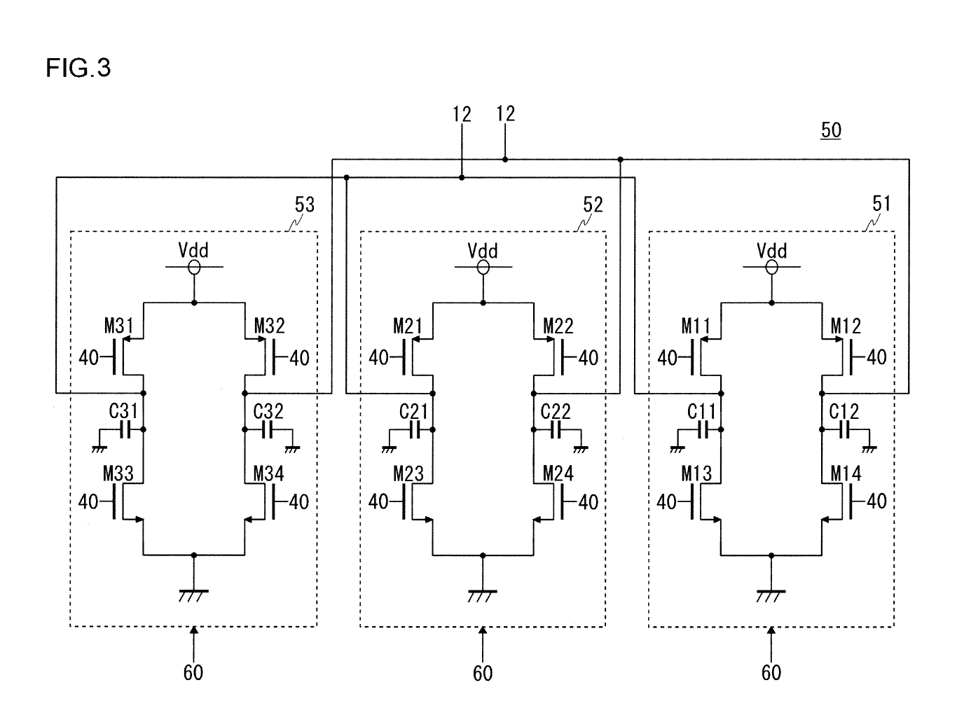

FIG. 3 is a diagram illustrating an exemplary configuration of the H-bridge drive unit 50 according to the embodiment. The H-bridge drive unit 50 has a plurality of H-bridge circuits (a first H-bridge circuit 51, a second H-bridge circuit 52, and a third H-bridge circuit 53 in FIG. 3) with a shared output path.

The first H-bridge circuit 51 includes a 1₁-th transistor M11, a 2₁-th transistor M12, a 3₁-th transistor M13, a 4₁-th transistor M14, a 1₁-th capacitor C11, and a 2₁-th capacitor C12. In FIG. 3, the 1₁-th transistor M11 and the 2₁-th transistor M12 are formed of P-channel MOSFET, and the 3₁-th transistor M13 and the 4₁-th transistor M14 are formed of N-channel MOSFET.

Source terminals of the 1₁-th transistor M11 and the 2₁-th transistor M12 are connected to a power supply potential Vdd, and gate terminals of the 1₁-th transistor M11 and the 2₁-th transistor M12 receive a positive PWM drive voltage and a negative PWM drive voltage from the PWM modulation unit 40, respectively.

Source terminals of the 3₁-th transistor M13 and the 4₁-th transistor M14 are connected to a ground potential, and gate terminals of the 3₁-th transistor M13 and the 4₁-th transistor M14 receive a positive PWM drive voltage and a negative PWM drive voltage from the PWM modulation unit 40, respectively.

A drain terminal of the 1₁-th transistor M11 and a drain terminal of the 3₁-th transistor M13 are connected to each other, and a positive drive current is provided to the drive element 12 from the connecting point. The 1₁-th capacitor C11 is connected between the connecting point and a predetermined fixed potential (a ground potential in FIG. 3).

A drain terminal of the 2₁-th transistor M12 and a drain terminal of the 4₁-th transistor M14 are connected to each other, and a negative drive current is provided to the drive element 12 from the connecting point. The 2₁-th capacitor C12 is connected between the connecting point and a predetermined fixed potential (a ground potential in FIG. 3). A loss in the sharpness of the edges of the drive current waveform can be adjusted by capacitance values of the 1₁-th capacitor C11 and the 2₁-th capacitor C12.

A positive current flows through the drive element 12 when the 1₁-th transistor M11 and the 4₁-th transistor M14 are controlled to be on and when the 2₁-th transistor M12 and the 3₁-th transistor M 13 are controlled to be off, by the positive PWM drive voltage and the negative PWM drive voltage. A negative current flows through the drive element 12 when the 1₁-th transistor M11 and the 4₁-th transistor M14 are controlled to be off and when the 2₁-th transistor M12 and the 3₁-th transistor M 13 are controlled to be on, by the positive PWM drive voltage and the negative PWM drive voltage.

The respective configurations of the second H-bridge circuit 52 and the third H-bridge circuit 53 are the same as the configuration of the first H-bridge circuit 51. The respective specifications of a 1₂-th transistor M21, a 2₂-th transistor M22, a 3₂-th transistor M23, a 4₂-th transistor M24, a 1₂-th capacitor C21, and a 2₂-th capacitor C22 included in the second H-bridge circuit 52 may be changed to the respective specifications of the corresponding constituent elements included in the first H-bridge circuit 51. The same applies to a 1₃-th transistor M31, a 2₃-th transistor M32, a 3₃-th transistor M33, a 4₃-th transistor M34, a 1₃-th capacitor C31, and a 2₃-th capacitor C32 included in the third H-bridge circuit 53.

A positive drive current of the first H-bridge circuit 51, a positive drive current of the second H-bridge circuit 52, and a positive drive current of the third H-bridge circuit 53 are added up according to Kirchhoff's current law and provided to a positive terminal of the drive element 12. Similarly, a negative drive current of the first H-bridge circuit 51, a negative drive current of the second H-bridge circuit 52, and a negative drive current of the third H-bridge circuit 53 are added up according to Kirchhoff's current law and provided to a negative terminal of the drive element 12.

The slew-rate control unit 60 determines the number of H-bridge circuits to be activated among a plurality of H-bridge circuits in accordance with a control signal generated by the equalizer 30. More specifically, the slew-rate control unit 60 classifies the value of the control signal into any one of a plurality of sections and determines, according to the sections, the number of H-bridge circuits to be activated. In order to disable an H-bridge circuit, the power of the H-bridge circuit may be disconnected, or all the transistors that constitute the H-bridge circuit may be turned off so as to create a high impedance state.

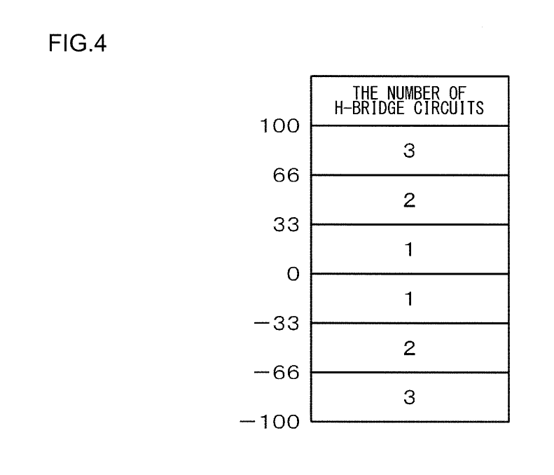

FIG. 4 is a diagram explaining a plurality of sections to be selected by the slew-rate control unit 60. In the figure, the value of the control signal generated by the equalizer 30 is normalized, and the value of the normalized control signal is shown in a range of +100 to −100. The value is zero when there is no difference between the target position and the detected position of the lens 10. The value is +100 when the target position and the detected position are the farthest away from each other in the near (or far) direction, and the value is −100 when the target position and the detected position are the farthest away from each other in the far (near) direction.

The slew-rate control unit 60 activates one H-bridge circuit when the value of the control signal is in a range of 0 to plus/minus 33, two H-bridge circuits when the value of the control signal is in a range of plus/minus 34 to plus/minus 66, respectively, and three H-bridge circuits when the value of the control signal is in a range of plus/minus 67 to plus/minus 100, respectively. In other words, control is performed so that, the farther away the detected position is from the target position, the larger a current becomes that is provided to the drive element 12. In contrast, control is performed so that, the closer the detected position is to the target position, the smaller a current becomes that is provided.

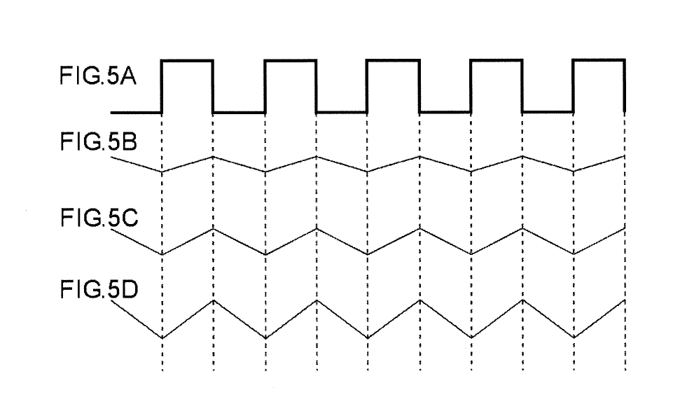

FIG. 5 is a diagram illustrating an example of a current waveform generated by the H-bridge drive unit 50. FIG. 5A illustrates a normal PWM output current waveform. FIG. 5B illustrates an output current waveform when one of H-bridge circuits included in the H-bridge drive unit 50 is activated. FIG. 5C illustrates an output current waveform when two of the H-bridge circuits included in the H-bridge drive unit 50 are activated. FIG. 5D illustrates an output current waveform when three of the H-bridge circuits included in the H-bridge drive unit 50 are activated.

As described above, in a device that is provided with an element driven by a PWM drive current and that performs feedback control for maintaining the state of an object to be a predetermined state, noise attributed to the PWM drive current can be reduced by adaptively changing the drive current capability in accordance with a difference between a target value and an actual measured value, according to the present embodiment. In other words, when the difference between the target value and the actual measured value is small, by adjusting the slope of an edge of the PWM drive current waveform to be moderately inclined, high-frequency noise attributed to the edge can be reduced. A large drive force is not necessary when the difference is small. Thus, a desired goal can still be achieved by the adjusted drive current.

When this is applied to an auto-focus control circuit, a reduction in the image quality can be prevented that is due to high-frequency noise attributed to an edge of a PWM drive current waveform.

Described above is an explanation of the present invention based on several embodiments. These embodiments are intended to be illustrative only, and it will be obvious to those skilled in the art that various modifications to constituting elements and processes could be developed and that such modifications are also within the scope of the present invention.

For example, hysteresis may be provided for the above switching of sections by the slew-rate control unit 60. For example, the slew-rate control unit 60 may perform control such that the section is switched to a specific section when a section into which the value of the control signal is classified is moved from the current section to the specific section for a predetermined number of settings within a predetermined setting period and such that the section remains to be the current section when the number of settings is not reached. Also, a dead zone for maintaining the current section may be provided between sections. A situation where unnecessary switching of a PWM drive current waveform occurs can be prevented by these controls.

In the above embodiments, a voice coil motor is used for the drive element 12. Instead, a piezoelectric element, a stepping motor, or the like may also be used. A hall element is used for the position detection element 14. Instead, an MR element, a photo screen diode, or the like may also be used. The number of H-bridge circuits included in the H-bridge drive unit 50 is not limited to three. The number may be two or may be four or more.

What is claimed is:

1. A drive control circuit comprising:
an equalizer configured to generate, based on a difference between a target value for the state of an object and an actual measured value thereof, a control signal for adjusting the state of the object to match the target value;
a PWM modulation unit configured to generate a PWM signal corresponding to the control signal generated by the equalizer;
an H-bridge drive unit configured to generate a drive current for driving a drive element that changes the state of the object in accordance with the PWM signal generated by the PWM modulation unit; and
a slew-rate control unit configured to change the current driving capability of the H-bridge drive unit in accordance with the control signal.

2. The drive control circuit according to claim 1, wherein the slew-rate control unit increases the current driving capability as the difference between the target value and the actual measured value increases.

3. The drive control circuit according to claim 1, wherein the H-bridge drive unit has a plurality of H-bridge circuits with a shared output path, and
the slew-rate control unit determines the number of H-bridge circuits to be activated among the plurality of H-bridge circuits.

4. The drive control circuit according to claim 3, wherein the slew-rate control unit classifies the value of the control signal into any one of a plurality of sections and determines, according to the sections, the number of the H-bridge circuits to be activated.

5. A focus control circuit mounted on an image capturing device provided with a lens, a drive element for adjusting the position of the lens, and a position detection element for detecting the position of the lens, comprising:
an equalizer configured to generate a control signal for adjusting, based on a difference between the position of the lens identified by an output signal from the position detection element and a target position of the lens that is set from the outside, the position of the lens to match the target position;
a PWM modulation unit configured to generate a PWM signal corresponding to the control signal generated by the equalizer;
an H-bridge drive unit configured to generate a drive current for driving the drive element in accordance with the PWM signal generated by the PWM modulation unit; and
a slew-rate control unit configured to change the current driving capability of the H-bridge drive unit in accordance with the control signal.
